(19) United States
(12) Patent Application Publication
(10) Pub. No.: US 2026/0265588 A1
(43) Pub. Date: Sep. 10, 2026

(54) ADHESIVE COMPOSITION

(71) Applicant: Dow Global Technologies LLC, Midland, MI (US)

(72) Inventors: Stacy L Pesek, Pearland, TX (US); Shankar CV Ram, Missouri City, TX (US)

(21) Appl. No.: 19/165,798

(22) PCT Filed: May 30, 2024
(86) PCT No.: PCT/US2024/031665

§ 371 Date: Sep. 16, 2025

Related U.S. Application Data
(60) Provisional application No. 63/504,983, filed on May 30, 2023.
(60) Provisional application No. 63/579,872, filed on Aug. 31, 2023.

(51) Int. Cl. C09J 123/08; C09J 145/00

(52) U.S. Cl. CPC C09J 123/0815; C09J 145/00

(57) ABSTRACT

The present application provides adhesive compositions comprising: (A) an ethylene/alpha-olefin elastomer; (B) a functionalized ethylene/alpha-olefin interpolymer; (C) a rosin based tackifier; and (D) a hydrocarbon based tackifier.

### CROSS-REFERENCE

This application claims priority to U.S. Provisional Application No. 63/579,872 filed on Aug. 31, 2023, and U.S. Provisional Application No. 63/504,983, filed on May 30, 2023, the contents of each or incorporated herein in their entirety.

### FIELD

This application related generally to adhesive compositions comprising polyolefin elastomers and rosin ester derivatives.

### BACKGROUND

In the adhesive industry, polyolefin elastomers have generally been formulated with hydrogenated tackifiers for hot melt adhesives (HMA), to achieve superior adhesive performance. However, hydrogenated tackifiers are expensive to produce, and can be in tight supply as petroleum feedstock supply tightens. An attractive alternative to hydrogenated tackifiers are rosin-based tackifiers (tackifiers derived from rosin). Rosin-based tackifiers are derived from naturally occurring hydrocarbon secretions of many plants and lower in cost than hydrogenated tackifiers. However, rosin-based tackifiers are inherently incompatible with polyolefin elastomers. Therefore, a need exists for new adhesive compositions which have improved compatibility between polyolefin elastomers and the rosin-based tackifier, as well as suitable adhesive performance.

### SUMMARY

The present application provides adhesive compositions comprising:
(A) an ethylene/alpha-olefin elastomer;
(B) a functionalized ethylene/alpha-olefin interpolymer;
(C) a rosin based tackifier; and
(D) a hydrocarbon based tackifier.

### BRIEF DESCRIPTION OF THE DRAWINGS

FIG. 1 depicts the cloud point curve of blends with AFFINITY™ GA 1950 and SYLVALITE™ 2200 rosin ester.

FIG. 2 depicts the cloud point curve of blends with AFFINITY™ GA 1950, AFFINITY™ GA 1000R and 1:1 ratio of SYLVALITE™ 2200 rosin ester tackifier and a hydrogenated hydrocarbon tackifier as described in inventive examples 9, 10, and 11.

FIG. 3 depicts the cloud point curve of blends with AFFINITY™ GA 1950, AFFINITY™ GA 1000R and 1:1 ratio of SYLVALITE™ 2200 rosin ester tackifier and a hydrogenated hydrocarbon tackifier as described in inventive examples 9, 10, and 11 as well we the control cloud point curve of AFFINITY™ GA 1950 and SYLVALITE™ 2200 rosin ester.

FIG. 4 depicts the Cloud Point (deg C.) increases of the inventive adhesive formulations of Table 8.

FIG. 5 depicts the two regions of Cloud Point behavior as a function of rosin ester tackifier for Table 8 inventive adhesive formulations.

FIG. 6 depicts Cloud Point by TST results for blend compositions as a function of GA 1000R polymer for Table 8 inventive adhesive formulations.

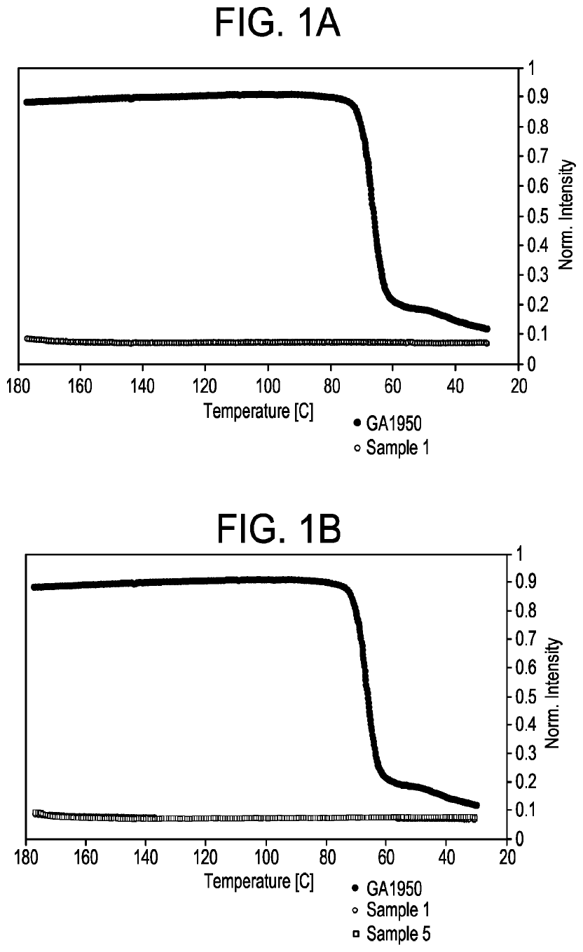

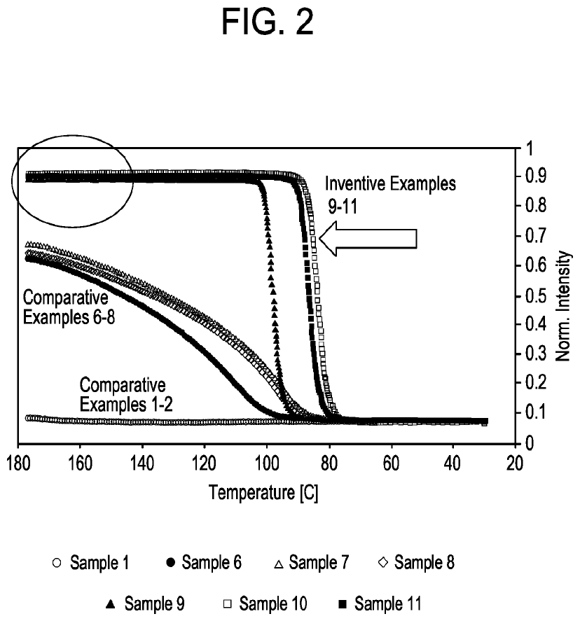

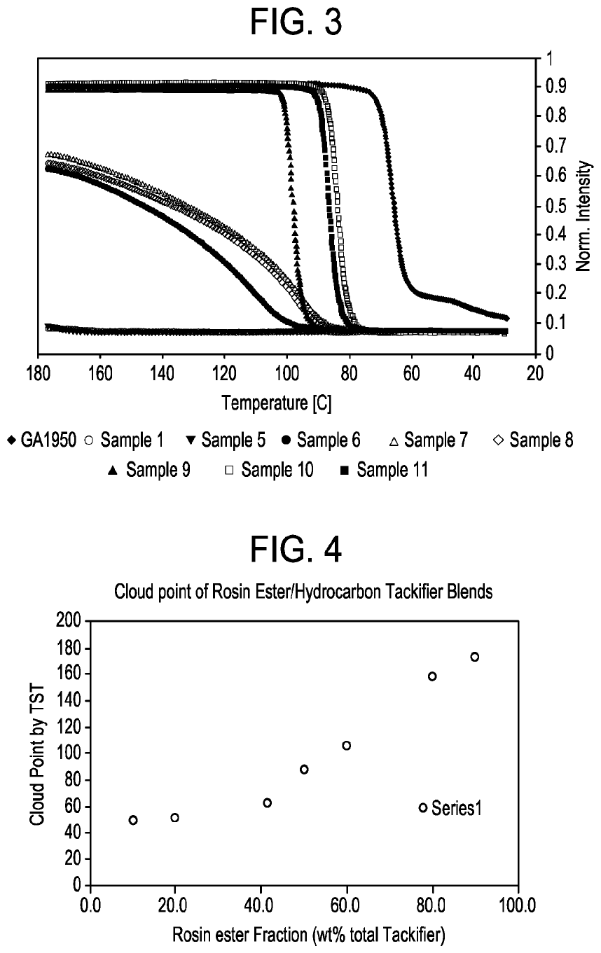

### DEFINITIONS

Unless stated to the contrary, implicit from the context, or customary in the art, all parts and percents are based on weight and all test methods are current as of the filing date of this disclosure.

Any reference to the Periodic Table of Elements is that as published by CRC Press, Inc., 1990-1991. Reference to a group of elements in this table is by the new notation for numbering groups. For purposes of United States patent practice, the contents of any referenced patent, patent application or publication are incorporated by reference in their entirety (or its equivalent US version is so incorporated by reference) especially with respect to the disclosure of definitions (to the extent not inconsistent with any definitions specifically provided in this disclosure) and general knowledge in the art. The numerical ranges disclosed herein include all values from, and including, the lower and upper value. For ranges containing explicit values (e.g., 1 or 2; or 3 to 5; or 6; or 7), any subrange between any two explicit values is included (e.g., 1 to 2; 2 to 6; 5 to 7; 3 to 7; 5 to 6; etc.).

An “adhesive composition” is a mixture of components that is capable of joining substrates of interest together under an application of heat and/or pressure. A non-limiting example of a suitable adhesive composition is a hot melt adhesive (HMA) composition. A “hot melt adhesive (HMA) composition” is a mixture of components that is capable of joining substrates of interest together under the application of heat, or more typically, the application of heat and pressure.

The term “alkyl group” refers to an organic radical derived from an aliphatic hydrocarbon by deleting one hydrogen atom therefrom. An alkyl group may be a linear, branched, cyclic or a combination thereof. In an embodiment, the alkyl group is a C₁-C₂₀ alkyl group.

The term “composition” refers to a mixture of materials which comprise the composition, as well as reaction products and decomposition products formed from the materials of the composition.

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed.

An “ethylene-based polymer” or “ethylene polymer” is a polymer that contains a majority amount of polymerized ethylene based on the weight of the polymer, and, optionally, may comprise at least one comonomer. An “ethylene-based interpolymer” is an interpolymer that contains, in polymerized form, a majority amount of ethylene, based on the weight of the interpolymer, and at least one comonomer. Preferably, the ethylene-based interpolymer is a random interpolymer (i.e., comprises a random distribution of it monomeric constituents). A nonlimiting example of a suitable ethylene-based interpolymer is an ethylene plastomer/elastomer.

An “ethylene/α-olefin interpolymer” is an interpolymer that contains a majority amount of polymerized ethylene, based on the weight of the interpolymer, and at least one α-olefin. An “ethylene/α-olefin copolymer” is an interpolymer that contains a majority amount of polymerized ethylene, based on the weight of the copolymer, and an «-olefin, as the only two monomer types.

“Ethylene plastomers/elastomers” are substantially linear, or linear, ethylene/α-olefin copolymers containing homogeneous short-chain branching distribution comprising units derived from ethylene and units derived from at least one C₃-C₁₀ α-olefin comonomer, or at least one C₄-C₈ α-olefin comonomer, or at least one C₆-C₈ α-olefin comonomer. Ethylene plastomers/elastomers have a density from 0.870 g/cc, or 0.880 g/cc, or 0.890 g/cc to 0.900 g/cc, or 0.902 g/cc, or 0.904 g/cc, or 0.909 g/cc, or 0.910 g/cc, or 0.917 g/cc. Nonlimiting examples of ethylene plastomers/elastomers include AFFINITY™ plastomers and elastomers (available from The Dow Chemical Company), EXACT™ Plastomers (available from ExxonMobil Chemical), Tafmer™ (available from Mitsui), Nexlene™ (available from SK Chemicals Co.), and Lucene™ (available LG Chem Ltd.).

The term “heteroatom” refers to an atom other than carbon or hydrogen. Nonlimiting examples of suitable heteroatoms include: F, Cl, Br, N, O, P, B, S, Si, Sb, Al, Sn, As, Se and Ge. The terms, “hydrocarbyl” and “hydrocarbon” refer to substituents containing only hydrogen and carbon atoms, including branched or unbranched, saturated or unsaturated, cyclic, polycyclic or noncyclic species. Nonlimiting examples include alkyl-, cycloalkyl-, alkenyl-, alkadienyl-, cycloalkenyl-, cycloalkadienyl-, aryl-, and alkynyl-groups.

An “interpolymer” is a polymer prepared by the polymerization of at least two different types of monomers. The generic term interpolymer thus includes copolymers (employed to refer to polymers prepared from two different types of monomers), and polymers prepared from more than two different types of monomers.

An “olefin-based polymer” or “polyolefin” is a polymer that contains a majority amount of polymerized olefin monomer, for example, ethylene or propylene, (based on the weight of the polymer), and optionally, may contain at least one comonomer. Nonlimiting examples of an olefin-based polymer include an ethylene-based polymer and a propylene-based polymer.

A “polymer” is a polymeric compound prepared by polymerizing monomers, whether of the same or a different type. The generic term polymer thus embraces the term “homopolymer” (employed to refer to polymers prepared from only one type of monomer, with the understanding that trace amounts of impurities can be incorporated into the polymer structure), and the term “interpolymer,” as defined hereinafter. Trace amounts of impurities, for example, catalyst residues, may be incorporated into and/or within the polymer.

The term “fully hydrogenated,” as used herein, refers to a hydrogenation level greater than 90%. The term “partially hydrogenated,” as used herein, refers to a hydrogenation level from 50% to 90%. The term “non-hydrogenated,” as used herein, refers to a hydrogenation level less than 50%. The hydrogenation level can be determined by those skilled in the art, for example, by proton (1H) NMR.

### DETAILED DESCRIPTION

As discussed above, there is a strong desire among adhesive formulators and suppliers to provide end users with increasing bio-sourced or more sustainably sourced ingredients. Rosin ester based tackifiers have a lower carbon footprint that traditional hydrocarbon based tackifiers. However, polyolefins, such as AFFINITY™ GA, are inherently not compatible with rosin ester based tackifiers, but do have good compatibility with hydrogenated hydrocarbon tackifiers.

Applicants have surprisingly found that a specific combination of ingredients, that combine rosin ester tackifiers, hydrogenated hydrocarbon tackifiers with polyolefin elastomer and a functionalized polyolefin compatibilizer, there is a significant improvement in the compatibility of blends.

Accordingly, the present application provides adhesive compositions comprising:
(A) an ethylene/alpha-olefin elastomer;
(B) a functionalized ethylene/alpha-olefin interpolymer;
(C) a rosin based tackifier; and
(D) a hydrocarbon based tackifier.

### Ethylene/Alpha-Olefin Elastomer

In one embodiment, the composition further comprises component A) an ethylene/alpha-olefin interpolymer, and further an ethylene/alpha-olefin copolymer. Preferred α-olefins include, but are not limited to, C3-C20 α-olefins, and preferably C3-C10 α-olefins. More preferred α-olefins include propylene, 1-butene, 1-pentene, 1-hexene, 1-heptene and 1-octene, and more preferably include propylene, 1-butene, 1-hexene and 1-octene.

In one embodiment, the ethylene/alpha-olefin interpolymer, and further copolymer, of component A, has a melt viscosity less than, or equal to, 40,000 cP, further less than, or equal to, 30,000 cP, further less than, or equal to, 20,000 cP, and further less than, or equal to, 10,000 cP, at 350° F. (177° C.). Preferred alpha-olefins are discussed above.

In one embodiment, ethylene/alpha-olefin interpolymer, and further copolymer, of component A, has a melt viscosity greater than, or equal to, 2,000 cP, further greater than, or equal to, 3,000 cP, further greater than, or equal to, 4,000 cP, and further greater than, or equal to, 5,000 cP, at 350° F. (177° C.). Preferred alpha-olefins are discussed above.

In one embodiment, the ethylene/alpha-olefin interpolymer, and further copolymer, of component A, has a melt viscosity from 2,000 cP to 40,000 cP, further from 3,000 cP to 30,000 cP, further from 4,000 cP to 20,000 cP, at 350° F. (177° C.), and further from 5,000 cP to 10,000 cP, at 350° F. (177° C.). Preferred alpha-olefins are discussed above.

In one embodiment, the ethylene/alpha-olefin interpolymer, and further copolymer, of component A, has a molecular weight distribution (Mw/Mn) less than, or equal to, 3.5, further less than, or equal to, 3.0, further less than, or equal to, 2.5, and further less than, or equal to, 2.3. In a further embodiment, the ethylene/alpha-olefin interpolymer is an ethylene/α-olefin copolymer. Preferred alpha-olefins are discussed above.

In one embodiment, the ethylene/alpha-olefin interpolymer, and further copolymer, of component A, has a molecular weight distribution (Mw/Mn) greater than, or equal to, 1.1, further greater than, or equal to, 1.3, further greater than, or equal to, 1.5, and further greater than, or equal to, 1.7. In a further embodiment, the ethylene/alpha-olefin interpolymer is an ethylene/α-olefin copolymer. Preferred alpha-olefins are discussed above.

In one embodiment, the ethylene/alpha-olefin interpolymer, and further copolymer, of component A, has a weight average molecular weight distribution (Mw) less than, or equal to, 40,000 g/mole, further less than, or equal to, 30,000 g/mole, further less than, or equal to, 25,000 g/mole. Preferred alpha-olefins are discussed above.

In one embodiment, the ethylene/alpha-olefin interpolymer, and further copolymer, of component A, has a weight average molecular weight distribution (Mw) greater than, or equal to, 2000 g/mole, further greater than, or equal to, 3000 g/mole, further greater than, or equal to, 4000 g/mole. Preferred alpha-olefins are discussed above.

In one embodiment, the ethylene/alpha-olefin interpolymer, and further copolymer, of component A, has a melt index (12 or MI), or calculated melt index (12 or MI), greater than, or equal to, 400 g/10 min, further greater than, or equal to, 600 g/10 min, and more further greater than, or equal to, 800 g/10 min. Preferred alpha-olefins are discussed above.

In one embodiment, the ethylene/alpha-olefin interpolymer, and further copolymer, of component A, has a melt index (12 or MI), or calculated melt index (12 or MI), less than, or equal to, 2000 g/10 min, further less than, or equal to, 1500 g/10 min, and further less than, or equal to, 1200 g/10 min. Preferred alpha-olefins are discussed above.

In one embodiment, the ethylene/alpha-olefin interpolymer, and further copolymer, of component A, has a percent crystallinity of less than, or equal to, 40 percent, further less than, or equal to, 30 percent, and further less than, or equal to, 20 percent, as determined by DSC. Preferred alpha-olefins are discussed above.

In one embodiment, the ethylene/alpha-olefin interpolymer, and further copolymer, of component A, has a percent crystallinity of greater than, or equal to, 2 percent, further greater than, or equal to, 5 percent, and further greater than, or equal to, 10 percent, as determined by DSC. Preferred alpha-olefins are discussed above.

In one embodiment, the ethylene/alpha-olefin interpolymer, and further copolymer, of component A, has a density greater than, or equal to, 0.855 g/cc, further greater than, or equal to, 0.860 g/cc, add further greater than, or equal to, 0.865 g/cc. Preferred alpha-olefins are discussed above.

In one embodiment, the ethylene/alpha-olefin interpolymer, and further copolymer, of component A, has a density less than, or equal to, 0.900 g/cc, further less than, or equal to, 0.895 g/cc, further less than, or equal to, 0.890 g/cc, and further less than, or equal to, 0.885 g/cc. Preferred alpha-olefins are discussed above. Preferred alpha-olefins are discussed above.

In one embodiment, the ethylene/alpha-olefin interpolymer, and further copolymer, of component A, has a density from 0.855 g/cm³ to 0.900 g/cm³, further from 0.860 g/cm³ to 0.895 g/cm³, and further from 0.865 g/cm³ to 0.890 g/cm³. Preferred alpha-olefins are discussed above. Preferred alpha-olefins are discussed above.

In one embodiment, the ethylene/α-olefin interpolymer of component A is a homogeneously branched linear interpolymer, and further a copolymer, or a homogeneous branched substantially linear interpolymer, and further a copolymer. Preferred alpha-olefins are discussed above.

In one embodiment, the ethylene/α-olefin interpolymer of component A is a homogeneously branched linear interpolymer, further a copolymer.

In one embodiment, the ethylene/α-olefin interpolymer of component A is a homogeneous branched substantially linear interpolymer, further a copolymer.

Some examples of ethylene/α-olefin copolymers include AFFINITY™ GA Polyolefin Plastomers, available from The Dow Chemical Company, and LICOCENE Performance Polymers from Clariant. Some examples of preferred ethylene/α-olefin copolymers include AFFINITY™ GA 1900, AFFINITY™ GA 1950, AFFINITY™ GA 1875, XUS 38628.00 all available from The Dow Chemical Company. Other examples of ethylene/α-olefin interpolymers, suitable for the invention, include the ultra-low molecular weight ethylene polymers described in U.S. Pat. Nos. 6,335,410, 6,054,544 and 6,723,810, each fully incorporated herein by reference.

### Functionalized Ethylene/Alpha-Olefin Interpolymer

In one embodiment, component B is an anhydride and/or carboxylic acid functionalized ethylene/alpha-olefin interpolymer, and further an anhydride and/or carboxylic acid grafted ethylene/alpha-olefin copolymer. Preferred α-olefins include, but are not limited to, C3-C20 α-olefins, and preferably C3-C10 α-olefins. More preferred α-olefins include propylene, 1-butene, 1-pentene, 1-hexene, 1-heptene and 1-octene, and more preferably include propylene, 1-butene, 1-hexene and 1-octene.

In one embodiment, the anhydride and/or carboxylic acid functionalized ethylene/alpha-olefin interpolymer of component B has a density greater than, or equal to, 0.857 g/cc, further greater than, or equal to, 0.860 g/cc, add further greater than, or equal to, 0.865 g/cc. In a further embodiment, the anhydride and/or carboxylic acid functionalized ethylene/alpha-olefin interpolymer is an anhydride and/or carboxylic acid functionalized ethylene/α-olefin copolymer. Some preferred α-olefins are discussed above.

In one embodiment, the anhydride and/or carboxylic acid functionalized ethylene/alpha-olefin interpolymer of component B has a density less than, or equal to, 0.892 g/cc, further less than, or equal to, 0.890 g/cc, and further less than, or equal to, 0.885 g/cc. In a further embodiment, the anhydride and/or carboxylic acid functionalized ethylene/alpha-olefin interpolymer is an anhydride and/or carboxylic acid functionalized ethylene/α-olefin copolymer. Some preferred α-olefins are discussed above.

In one embodiment, the anhydride and/or carboxylic acid functionalized ethylene/alpha-olefin interpolymer of component B has a density from 0.855 g/cc to 0.890 g/cc, further from 0.855 g/cc to 0.885 g/cc, and further from 0.855 g/cc to 0.880 g/cc (1 cc=1 cm³). In a further embodiment, the anhydride and/or carboxylic acid functionalized ethylene/alpha-olefin interpolymer is an anhydride and/or carboxylic acid functionalized ethylene/α-olefin copolymer. Some preferred α-olefins are discussed above.

In one embodiment, the anhydride and/or carboxylic acid functionalized ethylene/alpha-olefin interpolymer of component B has a density from 0.857 g/cc to 0.892 g/cc, further from 0.860 g/cc to 0.890 g/cc, and further from 0.865 g/cc to 0.885 g/cc. In a further embodiment, the anhydride and/or carboxylic acid functionalized ethylene/alpha-olefin interpolymer is an anhydride and/or carboxylic acid functionalized ethylene/α-olefin copolymer. Some preferred α-olefins are discussed above.

If the density of component B is greater than 0.895 g/cc, than the adhesion of the final composition is reduced because of the increased rigidity of the polymer.

In one embodiment, the anhydride and/or carboxylic acid functionalized ethylene/alpha-olefin interpolymer of Component B comprises greater than, or equal to, 0.5 weight percent, further greater than, or equal to, 0.7 weight percent, further greater than, or equal to, 0.9 weight percent, of the anhydride and/or carboxylic acid functionality, based on the weight of the polymer. In a further embodiment, the anhydride and/or carboxylic acid functionalized ethylene/alpha-olefin interpolymer is an anhydride and/or carboxylic acid functionalized ethylene/α-olefin copolymer. Some preferred α-olefins are discussed above.

In one embodiment, the anhydride and/or carboxylic acid functionalized ethylene/alpha-olefin interpolymer of Component B comprises from 0.9 to 1.5 weight percent, further from 0.9 to 1.4 weight percent, further from 0.9 to 1.3 weight percent of the anhydride and/or carboxylic acid functionality, based on the weight of the polymer. In a further embodiment, the anhydride and/or carboxylic acid functionalized ethylene/alpha-olefin interpolymer is an anhydride and/or carboxylic acid functionalized ethylene/α-olefin copolymer. Some preferred α-olefins are discussed above.

In one embodiment, the where in the ethylene/alpha-olefin elastomer and the functionalized ethylene/alpha-olefin interpolymer are present in the ratio of 4:1. of Component B has a melt viscosity less than, or equal to, 40,000 cP, further less than, or equal to, 30,000 cP, further less than, or equal to, 20,000 cP, and further less than, or equal to, 15,000 cP, at 350° F. (177° C.). In a further embodiment, the anhydride and/or carboxylic acid functionalized ethylene/alpha-olefin interpolymer is an anhydride and/or carboxylic acid functionalized ethylene/α-olefin copolymer. Some preferred α-olefins are discussed above.

In one embodiment, anhydride and/or carboxylic acid functionalized ethylene/alpha-olefin interpolymer of Component B has a melt viscosity greater than, or equal to, 2,000 cP, further greater than, or equal to, 3,000 cP, further greater than, or equal to, 4,000 cP, and further greater than, or equal to, 5,000 cP, at 350° F. (177° C.). In a further embodiment, the anhydride and/or carboxylic acid functionalized ethylene/alpha-olefin interpolymer is an anhydride and/or carboxylic acid functionalized ethylene/α-olefin copolymer. Some preferred α-olefins are discussed above.

In one embodiment, the anhydride and/or carboxylic acid functionalized ethylene/alpha-olefin interpolymer of component B has a melt viscosity from 2,000 cP to 50,000 cP, further from 3,000 cP to 40,000 cP, further from 4,000 cP to 30,000 cP, at 350° F. (177° C.), and further from 5,000 cP to 20,000 cP, at 350° F. (177° C.). In a further embodiment, the anhydride and/or carboxylic acid functionalized ethylene/alpha-olefin interpolymer is an anhydride and/or carboxylic acid functionalized ethylene/α-olefin copolymer. Some preferred α-olefins are discussed above.

In one embodiment, the anhydride and/or carboxylic acid functionalized ethylene/alpha-olefin interpolymer of component B has a molecular weight distribution (Mw/Mn) less than, or equal to, 5.0, further less than, or equal to, 4.0, further less than, or equal to, 3.0. In a further embodiment, the anhydride and/or carboxylic acid functionalized ethylene/alpha-olefin interpolymer is an anhydride and/or carboxylic acid functionalized ethylene/α-olefin copolymer. Some preferred α-olefins are discussed above.

In one embodiment, the anhydride and/or carboxylic acid functionalized ethylene/alpha-olefin interpolymer of component B has a molecular weight distribution (Mw/Mn) greater than, or equal to, 1.5, further greater than, or equal to, 2.0, and further greater than, or equal to, 2.5. In a further embodiment, the anhydride and/or carboxylic acid functionalized ethylene/alpha-olefin interpolymer is an anhydride and/or carboxylic acid functionalized ethylene/α-olefin copolymer. Some preferred α-olefins are discussed above.

In one embodiment, the anhydride and/or carboxylic acid functionalized ethylene/alpha-olefin interpolymer of component B has a molecular weight distribution (MWD) from 1.5 to 5.0, further from 2.0 to 4.0, further from 2.2 to 3.0. In a further embodiment, the anhydride and/or carboxylic acid functionalized ethylene/alpha-olefin interpolymer is an anhydride and/or carboxylic acid functionalized ethylene/α-olefin copolymer. Some preferred α-olefins are discussed above.

In one embodiment, the anhydride and/or carboxylic acid functionalized ethylene/alpha-olefin interpolymer of component B has a weight average molecular weight (Mw) less than, or equal to, 50,000 g/mole, further less than, or equal to, 40,000 g/mole, further less than, or equal to, 30,000 g/mole. In a further embodiment, the anhydride and/or carboxylic acid functionalized ethylene/alpha-olefin interpolymer is an anhydride and/or carboxylic acid functionalized ethylene/α-olefin copolymer. Some preferred α-olefins are discussed above.

In one embodiment, the anhydride and/or carboxylic acid functionalized ethylene/alpha-olefin interpolymer of component B has a weight average molecular weight (Mw) greater than, or equal to, 2000 g/mole, further greater than, or equal to, 3000 g/mole, further greater than, or equal to, 4000 g/mole. In a further embodiment, the anhydride and/or carboxylic acid functionalized ethylene/alpha-olefin interpolymer is an anhydride and/or carboxylic acid functionalized ethylene/α-olefin copolymer. Some preferred α-olefins are discussed above.

In one embodiment, the anhydride and/or carboxylic acid functionalized ethylene/alpha-olefin interpolymer of component B has a melt index (12), or calculated melt index (12), greater than, or equal to, 300 g/10 min, further greater than, or equal to, 400 g/10 min, and more further greater than, or equal to, 500 g/10 min. In a further embodiment, the anhydride and/or carboxylic acid functionalized ethylene/alpha-olefin interpolymer is an anhydride and/or carboxylic acid functionalized ethylene/α-olefin copolymer. Some preferred α-olefins are discussed above.

In one embodiment, the anhydride and/or carboxylic acid functionalized ethylene/alpha-olefin interpolymer of component B has a melt index (12), or calculated melt index (12), less than, or equal to, 1500 g/10 min, further less than, or equal to, 1200 g/10 min, and more further less than, or equal to, 1000 g/10 min. In a further embodiment, the anhydride and/or carboxylic acid functionalized ethylene/alpha-olefin interpolymer is an anhydride and/or carboxylic acid functionalized ethylene/α-olefin copolymer. Some preferred α-olefins are discussed above.

In one embodiment, the anhydride and/or carboxylic acid functionalized ethylene/alpha-olefin interpolymer of component B has a percent crystallinity of less than, or equal to, 40 percent, further less than, or equal to, 35 percent, further less than, or equal to, 30 percent, further less than, or equal to, 25 percent, and further less than, or equal to, 20 percent, as determined by DSC. In a further embodiment, the anhydride and/or carboxylic acid functionalized ethylene/alpha-olefin interpolymer is an anhydride and/or carboxylic acid functionalized ethylene/α-olefin copolymer. Some preferred α-olefins are discussed above.

In one embodiment, the anhydride and/or carboxylic acid functionalized ethylene/alpha-olefin interpolymer of component B has a percent crystallinity of greater than, or equal to, 2 percent, further greater than, or equal to, 5 percent, and further greater than, or equal to, 10 percent, as determined by DSC. In a further embodiment, the anhydride and/or carboxylic acid functionalized ethylene/alpha-olefin interpolymer is an anhydride and/or carboxylic acid functionalized ethylene/α-olefin copolymer. Some preferred α-olefins are discussed above.

Suitable functionalized copolymers include MAH-grafted copolymers (for example, AFFINITY™ GA 1000R Polyolefin Plastomers, available from The Dow Chemical Company).

An anhydride and/or carboxylic acid functionalized ethylene/alpha-olefin interpolymer of component B may comprise a combination of two or more embodiments as described herein.

An anhydride and/or carboxylic acid functionalized ethylene/alpha-olefin interpolymer of component B may comprise a combination of two or more embodiments as described herein.

The base polymer used to form the anhydride and/or carboxylic acid functionalized ethylene/α-olefin interpolymer is an ethylene/α-olefin copolymer. The following embodiments also may apply to the ethylene/alpha-olefin interpolymer of component A.

In one embodiment, the ethylene/α-olefin interpolymer, is an ethylene/α-olefin copolymer. Preferred α-olefins include, but are not limited to, C3-C20 α-olefins, and further C3-C10 α-olefins. More preferred α-olefins include propylene, 1-butene, 1-pentene, 1-hexene, 1-heptene and 1-octene, and more further include propylene, 1-butene, 1-hexene and 1-octene.

In one embodiment, the ethylene/α-olefin interpolymer has a melt viscosity less than, or equal to, 50,000 cP, further less than, or equal to, 40,000 cP, and further less than, or equal to, 30,000 cP, at 350° F. (177° C.). In a further embodiment, the ethylene/α-olefin interpolymer is an ethylene/α-olefin copolymer. Suitable α-olefins are discussed above.

In one embodiment, ethylene/α-olefin interpolymer has a melt viscosity greater than, or equal to, 2,000 cP, further greater than, or equal to, 4,000 cP, more further greater than, or equal to, 5,000 cP, at 350° F. (177° C.). In a further embodiment, the ethylene/α-olefin interpolymer is an ethylene/α-olefin copolymer. Suitable α-olefins are discussed above.

In one embodiment, the ethylene/α-olefin interpolymer has a melt viscosity from 2,000 cP to 20,000 cP, further from 4,000 cP to 16,000 cP, and further from 5,000 cP to 10,000 cP, at 350° F. (177° C.). In a further embodiment, the ethylene/α-olefin interpolymer is an ethylene/α-olefin copolymer. Suitable α-olefins are discussed above.

In one embodiment, the ethylene/α-olefin interpolymer has a molecular weight distribution (Mw/Mn) less than, or equal to, 5.0, and further less than, or equal to, 4.0, and further less than, or equal to, 3.0. Further, the ethylene/α-olefin interpolymers have a molecular weight distribution from 1.1 to 3.5, and further from 1.1 to 3.0, and further from 1.1 to 2.5. In a further embodiment, the ethylene/α-olefin interpolymer is an ethylene/α-olefin copolymer. Suitable α-olefins are discussed above.

In one embodiment, the ethylene/α-olefin interpolymer has a melt index (12 or MI), or calculated melt index (12 or MI), greater than, or equal to, 500 g/10 min, further greater than, or equal to, 800 g/10 min, and further greater than, or equal to, 1000 g/10 min. In a further embodiment, the ethylene/α-olefin interpolymer is an ethylene/α-olefin copolymer. Suitable α-olefins are discussed above.

In one embodiment, the ethylene/α-olefin interpolymer has a melt index (12 or MI), or calculated melt index (12 or MI), less than, or equal to, 2500 g/10 min, further less than, or equal to, 2000 g/10 min, and further less than, or equal to, 1500 g/10 min. In a further embodiment, the ethylene/α-olefin interpolymer is an ethylene/α-olefin copolymer. Suitable α-olefins are discussed above.

In one embodiment, the ethylene/α-olefin interpolymer has a percent crystallinity of less than, or equal to, 40 percent, further less than, or equal to, 30 percent, and further less than, or equal to, 20 percent, as determined by DSC. In a further embodiment, the ethylene/α-olefin interpolymer is an ethylene/α-olefin copolymer. Suitable α-olefins are discussed above.

In one embodiment, the ethylene/α-olefin interpolymer has a percent crystallinity of greater than, or equal to, 2 percent, further greater than, or equal to, 5 percent, and further greater than, or equal to, 10 percent, as determined by DSC. In a further embodiment, the ethylene/α-olefin interpolymer is an ethylene/α-olefin copolymer. Suitable α-olefins are discussed above.

In one embodiment, the ethylene/α-olefin interpolymer has a percent crystallinity from 2 to 30 percent, further from 5 to 25 percent, and further from 10 to 20 percent, as determined by DSC. In a further embodiment, the ethylene/α-olefin interpolymer is an ethylene/α-olefin copolymer. Suitable α-olefins are discussed above.

In one embodiment, the ethylene/α-olefin interpolymer has a density greater than, or equal to, 0.855 g/cc, further greater than, or equal to, 0.860 g/cc, further greater than, or equal to, 0.865 g/cc. In a further embodiment, the ethylene/α-olefin interpolymer is an ethylene/α-olefin copolymer. Suitable α-olefins are discussed above.

In one embodiment, the ethylene/α-olefin interpolymer has a density less than, or equal to, 0.895 g/cc, further less than, or equal to, 0.890 g/cc, further less than, or equal to, 0.880 g/cc. In a further embodiment, the ethylene/α-olefin interpolymer is an ethylene/α-olefin copolymer. Suitable α-olefins are discussed above.

In one embodiment, the ethylene/α-olefin interpolymers has a density from 0.855 g/cm³ to 0.890 g/cm³, and further from 0.860 g/cm³ to 0.885 g/cm³, and further from 0.865 g/cm³ to 0.880 g/cm³. In a further embodiment, the ethylene/α-olefin interpolymer is an ethylene/α-olefin copolymer. Suitable α-olefins are discussed above.

Some examples of ethylene/α-olefin copolymers include AFFINITY™ GA Polyolefin Plastomers, available from The Dow Chemical Company, and LICOCENE™ Performance Polymers from Clariant. Other examples of ethylene/α-olefin polymers suitable for the invention include the ultra-low molecular weight ethylene polymers described in U.S. Pat. Nos. 6,335,410, 6,054,544 and 6,723,810, each fully incorporated herein by reference.

In one embodiment, the ethylene/α-olefin interpolymer is a homogeneously branched linear interpolymer, and further a copolymer, or a homogeneous branched substantially linear interpolymer, and further a copolymer. Suitable α-olefins are discussed above.

In one embodiment, the ethylene/α-olefin interpolymer is a homogeneously branched linear interpolymer, and further a copolymer. Suitable α-olefins are discussed above.

In one embodiment, the ethylene/α-olefin interpolymer is a homogeneous branched substantially linear interpolymer, and further a copolymer. Suitable α-olefins are discussed above.

The terms “homogeneous” and “homogeneously-branched” are used in reference to an ethylene/α-olefin interpolymer, in which the α-olefin comonomer is randomly distributed within a given polymer molecule, and all of the polymer molecules have the same or substantially the same comonomer-to-ethylene ratio.

The homogeneously branched linear ethylene interpolymers are ethylene-based polymers, which lack measureable amounts of long chain branching, but do have short chain branches, derived from the comonomer polymerized into the interpolymer, and which are homogeneously distributed, both within the same polymer chain, and between different polymer chains. These ethylene/α-olefin interpolymers have a linear polymer backbone, no measurable long chain branching, and a narrow molecular weight distribution. This class of polymers is disclosed, for example, by Elston in U.S. Pat. No. 3,645,992, and subsequent processes to produce such polymers, using bis-metallocene catalysts, have been developed, as shown, for example, in EP 0 129 368; EP 0 260 999; U.S. Pat. Nos. 4,701,432; 4,937,301; 4,935,397; 5,055,438; and WO 90/07526; each incorporated herein by reference. As discussed, the homogeneously branched linear ethylene interpolymers lack long chain branching, just as is the case for the linear, low density polyethylene polymers or linear high density polyethylene polymers. Commercial examples of homogeneously branched linear ethylene/α-olefin interpolymers include TAFMER™ polymers from the Mitsui Chemical Company, and EXACT™ and EXCEED™ polymers from ExxonMobil Chemical Company.

The homogeneously branched substantially linear ethylene/α-olefin interpolymers are described in U.S. Pat. Nos. 5,272,236; 5,278,272; 6,054,544; 6,335,410 and 6,723,810; each incorporated herein by reference. The substantially linear ethylene/α-olefin interpolymers have long chain branching. The long chain branches have the same comonomer distribution as the polymer backbone, and can have about the same length as the length of the polymer backbone. “Substantially linear,” typically, is in reference to a polymer that is substituted, on average, with “0.01 long chain branches per 1000 total carbons” to “3 long chain branches per 1000 total carbons.” The length of a long chain branch is longer than the carbon length of a short chain branch, formed from the incorporation of one comonomer into the polymer backbone.

Some polymers may be substituted with “0.01 long chain branches per 1000 total carbons” to “3 long chain branch per 1000 total carbons,” further from “0.01 long chain branches per 1000 total carbons” to “2 long chain branch per 1000 total carbons,” and further from “0.01 long chain branches per 1000 total carbons” to “1 long chain branch per 1000 total carbons.”

The substantially linear ethylene/α-olefin interpolymers form a unique class of homogeneously branched ethylene-based polymers. They differ substantially from the well-known class of conventional, homogeneously branched linear ethylene/α-olefin interpolymers, as discussed above, and, moreover, they are not in the same class as conventional heterogeneous “Ziegler-Natta catalyst polymerized” linear ethylene polymers (for example, ultra-low density polyethylene (ULDPE), linear low density polyethylene (LLDPE) or high density polyethylene (HDPE), made, for example, using the technique disclosed by Anderson et al., in U.S. Pat. No. 4,076,698); nor are they in the same class as high pressure, free-radical initiated, highly branched polyethylenes, such as, for example, low density polyethylene (LDPE), ethylene-acrylic acid (EAA) copolymers and ethylene vinyl acetate (EVA) copolymers.

The homogeneously branched, substantially linear ethylene/α-olefin interpolymers useful in the invention have excellent processability, even though they have a relatively narrow molecular weight distribution. Surprisingly, the melt flow ratio (110/12), according to ASTM D 1238, of the substantially linear ethylene interpolymers can be varied widely, and essentially independently of the molecular weight distribution (Mw/Mn or MWD). This surprising behavior is contrary to conventional homogeneously branched linear ethylene interpolymers, such as those described, for example, by Elston in U.S. Pat. No. 3,645,992, and heterogeneously branched, conventional “Ziegler-Natta polymerized,” linear polyethylene interpolymers, such as those described, for example, by Anderson et al., in U.S. Pat. No. 4,076,698. Unlike substantially linear ethylene interpolymers, linear ethylene interpolymers (whether homogeneously or heterogeneously branched) have rheological properties, such that, as the molecular weight distribution increases, the I₁₀/I₂ value also increases.

Long chain branching can be determined by using ¹³C Nuclear Magnetic Resonance (NMR) spectroscopy, and can be quantified using the method of Randall (Rev. Macromol. Chem. Phys., C29 (2 &3), 1989, p. 285-297), two other methods are Gel Permeation Chromatography, couple with a Low Angle Laser Light Scattering detector (GPCLALLS), and Gel Permeation Chromatography, coupled with a Differential Viscometer detector (GPC-DV). The use of these techniques for long chain branch detection, and the underlying theories, have been well documented in the literature. See, for example, Zimm, B. H. and Stockmayer, W. H., J. Chem. Phys., 17, 1301 (1949); and Rudin, A., Modern Methods of Polymer Characterization, John Wiley & Sons, New York (1991) pp. 103-112.

In contrast to “substantially linear ethylene polymer,” “linear ethylene polymer” means that the polymer lacks measurable or demonstrable long chain branches, that is, the polymer is substituted with an average of less than 0.01 long chain branch per 1000 total carbons.

### Rosin Ester

The present composition includes a rosin ester. A “rosin ester” refers to a polymer containing, in polymerized form, rosin and, optionally, one or more dienes, which polymeric structure is then esterified with one or more polyols, and then the esterified polymeric structure is optionally hydrogenated. It is understood that as an ester, the rosin ester contains at least one ester group with oxygen atoms, the rosin ester thereby excluding tackifier composed only of hydrogen and carbon atoms. A “polyol” is an alcohol containing at least two hydroxyl groups (—OH).

A “rosin” is a hydrocarbon secretion of many plants, particularly coniferous trees such as Pinus palustris and Pinus caribaea. Natural rosin typically consists of a mixture of seven or eight rosin acids, and other minor components. Rosin is commercially available and can be obtained from pine trees by distillation of oleoresin (gum rosin being the residue of distillation), by extraction of pine stumps (wood rosin) or by fractionation of tall oil (tall oil rosin). A rosin is generally a mixture of rosin acids, which are carboxylic acids. These naturally occurring rosins may be suitably mixtures and/or isomers of monocarboxylic tricyclic rosin acids usually containing about 20 carbon atoms. The tricyclic rosin acids differ mainly in the position of the double bonds. The rosin acid may be at least one of levopimaric acid, neoabietic acid, palustric acid, abietic acid, dehydroabietic acid, seco-dehydroabietic acid, tetrahydroabietic acid, dihydroabietic acid, pimaric acid, paulstric acid, and isopimaric acid, or mixtures, isomers, and/or derivatives thereof. Nonlimiting examples of suitable rosins include gum rosin, wood rosin, tall oil rosin, and combinations thereof.

A “diene” is an unsaturated hydrocarbon containing two double bonds between carbon atoms. The diene can be conjugated-, non-conjugated-, straight chain-, branched chain- or cyclic-hydrocarbon diene having from 6 to 15 carbon atoms. Nonlimiting examples of suitable diene include 1,4-hexadiene; 1,6-octadiene; 1,7-octadiene; 1,9-decadiene; branched chain acyclic diene, such as 5-methyl-1,4-hexadiene, 3,7-dimethyl-1,6-octadiene, 3,7-dimethyl-1,7-octadiene and mixed isomers of dihydromyricene and dihydroocinene; single ring alicyclic dienes, such as 1,3-cyclopentadiene, 1,4-cyclohexadiene, 1,5-cyclooctadiene and 1,5-cyclododecadiene; and multi-ring alicyclic fused and bridged ring dienes, such as tetrahydroindene, methyl tetrahydroindene, dicyclopentadiene, and bicyclo-(2,2,1)-hepta-2,5-diene; alkenyl, alkylidene, cycloalkenyl and cycloalkylidene norbornenes, such as 5-methylene-2-norbornene (MNB), 5-propenyl-2-norbornene, 5-isopropylidene-2-norbornene, 5-(4-cyclopentenyl)-2-norbornene, 5-cyclohexylidene-2-norbornene, 5-vinyl-2-norbornene, norbornadiene, 5-ethylidene-2-norbornene (ENB), 5-vinylidene-2-norbornene (VNB), 5-methylene-2-norbornene (MNB), dicyclopentadiene (DCPD); and combinations thereof. Further nonlimiting examples of suitable diene include 4-methyl-1,4-hexadiene, 7-methyl-1,6-octadiene, 5,7-dimethyl-1,6-octadiene, 3,7,11-trimethyl-1,6,10-octatriene, 6-methyl-1,5-heptadiene, 1,3-butadiene, 1,6-heptadiene, 1,8-nonadiene, 1,9-decadiene, 1,10-undecadiene, 1,5-cyclododecadiene, bicyclo[2.2.1]hepta-2,5-diene (norbornadiene), tetracyclododecene, butadiene, dicyclopentadiene, vinyl norbornene, mixed isomers of dihydromyricene and dihydroocinene, tetrahydroindene, methyl tetrahydroindene, 5-propenyl-2-norbornene, 5-isopropylidene-2-norbornene, 5-(4-cyclopentenyl)-2-norbornene, 5-cyclohexylidene-2-norbornene, 5-vinyl-2-norbornene, and combinations thereof. In an embodiment, the diene is DCPD.

Rosin acids derived from natural sources also include rosins, i.e. rosin mixtures, modified notably by polymerisation, isomerisation, disproportionation and hydrogenation. The rosin acids may include those mentioned in U.S. Pat. Nos. 6,900,274; 6,875,842; 6,846,941; 6,344,573; 6,414,111; 4,519,952; and 6,623,554. A preferred rosin is tall rosin which is an isomeric mixture primarily composed of C20 fused-ring, monocarboxylic acid hydrocarbons typified by levopimaric and abietic acids. Any type of rosin may be used, including tall oil rosin, gum rosin and wood rosin. Examples of suitable commercially available rosins include tall oil rosins such as Sylvalite™ 2200, Sylvaros® 85, Sylvaros® 90 or Sylvaros® 95 from Kranton Chemical. Other examples of suitable rosin esters include FORAL™ 105-E, FORALYN™ 90, FORAL-AX-E™, PERMALYN™ 6110 available form the Eastman Chemical Company and KTP 95™ available from Komotac.

### Hydrocarbon Tackifiers

The present composition includes a hydrocarbon resin tackifier. These hydrocarbon tackifiers are produced mainly from petroleum-based by-products of naphtha crackers. The three major types are C5 aliphatic, C9 aromatic, and DCPD cyclo-aliphatic resins. Any type of hydrocarbon resin tackifier may be used based on commercial availability. Examples of suitable commercially available hydrocarbon tackifiers include C9 resins: Regalite™ R1125, DCPD resins: ESCAREZ™ and Regalite™ T1140, the C5 resins Eastotac™ H-100W Resin.

### Additives

The inventive compositions may further comprise a wax. Waxes include, but are not limited to, paraffin waxes, microcrystalline waxes, high density, low molecular weight polyethylene waxes, polypropylene waxes, thermally degraded waxes, by-product polyethylene waxes, Fischer-Tropsch waxes, oxidized Fischer-Tropsch waxes, and functionalized waxes, such as hydroxy stearamide waxes and fatty amide waxes. It is common in the art to use the terminology “synthetic high melting point waxes” to include high density, low molecular weight polyethylene waxes, by-product polyethylene waxes and Fischer-Tropsch waxes. Other waxes also include those described in U.S. Pat. Nos. 6,335,410; 6,054,544 and 6,723,810; which are all incorporated herein by reference. Preferred waxes include, but are not limited to, SASOL™ waxes (e.g., SASOLWAX™ H1 from Sasol Wax Company), and Fischer-Tropsch waxes. In one embodiment, the composition comprises from 10 to 40 weight percent, and further from 10 to 35 weight percent, and further from 10 to 30 weight percent of a wax, based on the weight of the composition.

Typically polymers used in the invention are treated with one or more stabilizers, for example, antioxidants, such as, for example, IRGANOX™ 1010, IRGANOX™ 1076, and IRGAFOS™ 168, now supplied by BASF. Polymers are typically treated with one or more stabilizers before an extrusion or other melt processes. Other polymeric additives include, but are not limited to, ultraviolet light absorbers, antistatic agents, pigments and dyes, nucleating agents, fillers, slip agents, fire retardants, plasticizers, processing aids, lubricants, stabilizers, smoke inhibitors, viscosity control agents and anti-blocking agents. The inventive compositions may also contain one or more thermoplastic polymers. In one embodiment, the composition comprises from 0.2 to 20 weight percent, and further from 0.10 to 10 weight percent, and further from 0.5 to 5 weight percent of an additive, based on the weight of the composition.

The inventive compositions may further comprise an oil. Oils are typically employed to reduce the viscosity of the adhesive. When employed, oils will be typically present in an amount less than 50 weight percent, preferably less than 20 weight percent, and more preferably less than 10 weight percent, based on the weight of the composition. Exemplary classes of oils include, but are not limited to, white mineral oil (such as KAYDOL™ oil available from Witco), and SHELLFLEX™ 371 naphthenic oil (available from Shell Oil Company) and CALSOL™ 5550 (napthenic oil from Calumet Lubricants).

### Applications

The inventive compositions may be prepared by standard melt blending procedures. In particular, the maleic anhydride-grafted polymer or blend, tackifier(s) and other components may be melt blended, until a homogeneous mix is obtained. Any mixing method producing a homogeneous blend, without degrading the adhesive components, is satisfactory, such as a vessel equipped with a stirrer, and an optional heating mechanism. The adhesives can be provided in forms, such as pellets, pillows, chiclets, drags, or any other desired configurations.

The inventive compositions may also be used in a variety of application, including, but not limited to, case and carton sealing, automotive, graphic arts, nonwovens, panel assembly, high performance tapes, contact hot melt adhesives, paperboard coatings, inks, personal care and cosmetic products, sealants, color and additive concentrates, carpet-tape adhesives, woodworking adhesives, and profile wrap adhesives.

### Test Methods

### Melt Viscosity

Melt viscosity is measured in accordance with ASTM D 3236 (350° F.), using a Brookfield Digital Viscometer (Model DV-III, version 3), and disposable aluminum sample chambers. The spindle used, in general, is a SC-31 hot-melt spindle, suitable for measuring viscosities in the range from 10 to 100,000 centipoise. The sample (polymer or adhesive composition) is poured into the chamber, which is, in turn, inserted into a Brookfield Thermosel, and locked into place. The sample chamber has a notch on the bottom that fits the bottom of the Brookfield Thermosel, to ensure that the chamber is not allowed to turn when the spindle is inserted and spinning. The sample (approximately 8-10 grams of resin) is heated to the required temperature, until the melted sample is about one inch below the top of the sample chamber. The viscometer apparatus is lowered, and the spindle submerged into the sample chamber. Lowering is continued, until the brackets on the viscometer align on the Thermosel. The viscometer is turned on, and set to operate at a shear rate, which leads to a torque reading in the range of 40 to 60 percent of the total torque capacity, based on the rpm output of the viscometer. Readings are taken every minute for about 15 minutes, or until the values stabilize, at which point, a final reading is recorded.

### Melt Index

Melt index (I2, or M1) of an ethylene-based polymer is measured in accordance with ASTM D-1238, condition 190° C./2.16 kg. For high 12 polymers (12 greater than, or equal to, 200 g/mole, melt index is preferably calculated from Brookfield viscosity as described in U.S. Pat. Nos. 6,335,410; 6,054,544; 6,723,810. I2(190° C./2.16 kg)=3.6126 [10^{(log η)-}6.6928)/−1.1363]−9.31851, where η=melt viscosity, in cP, at 350° F. (177° C.).

### Peel and Shear Strength

The peel adhesion fail temperature (PAFT) and shear adhesion failure temperature (SAFT) of the adhesives were tested using ASTM D-4498. Four samples (two for PAFT and two for SAFT) were put in a programmable oven, then “100 g weights” for PAFT, and “500 g weights” for SAFT, were attached to the samples. The test samples were equilibrated in an oven at 30° C., then the temperature of the oven was increased at a heating rate of 0.5° C./min. The failure time was recorded, and the failure temperature was calculated accordingly.

Two sheets of 6″×12″ Kraft paper were used for lamination. Bottom sheet has two pieces of masking tape separated by 1″ gap. The adhesive was spread by the bottom glass rod that is shimmed with tape. The top glass rod supplies compression. Silicone paper at the end was used to catch the excess adhesive. The final bond was defined by the two pieces of masking tape and was 1″ wide. The molten adhesive was heated to 177° C., and poured onto the bottom sheet. The glass rods were then quickly drawn across to make the lamination. The laminated sheet was trimmed, and cut widthwise into “1″ wide strips.” These strips had a “1″×1″ bond” in the center. The samples were conditioned for 24 hours at room temperature and 54 percent RH (Relative Humidity). Then the samples were placed in the oven, with 100 g in a peel mode, and 500 g in a shear mode. The oven temperature was increased at a rate of 30° C./h. The samples were hung from a switch that tripped when the samples failed, and the time and temperature were recorded by a computer. Two samples were tested for PAFT, and the average failure temperature recorded. Two samples were tested for SAFT, and the average failure temperature recorded.

### Heat Stress

The heat stress resistance was measured according to the “Suggested Test Method for Determining the Heat Stress Resistance of Hot Melt Adhesives,” method T-3006, prepared by the Institute of Packaging Professions (IoPP). To prepare one sample, two cardboard coupons (cut with flutes running in the long direction), having dimensions of 2″×3 3/16″ and 2″×5½,″ were bonded, by applying “0.00014 lb/in of adhesive” with an Olinger Bond Tester. The adhesive was applied perpendicular to the flutes, in the center of the shorter coupon, and the coupons were bonded, such that the adhesive was ¾″ from one end of the long coupon. Six replicates were made for each formulation. Samples were loaded into the sample holder, with the short coupon end aligned with the edge of the sample holder. The samples were held in place with the wide plate secured by wingnuts. A “200 g weight” was placed 3.94″ from the bond. The weight was secured by placing the peg, on the weight, into a hole made in the long coupon. The sample holder was then placed into a convection oven, at a set temperature, for 24 hours. If at least 80% of the bonds do not fail, than the sample was considered to have passed heat resistance at the test temperature. The oven temperature was varied, until the maximum passing heat stress resistance was determined. All new bonded coupon samples were used for each test temperature (six samples for each formulation and test temperature).

### Fiber Tear

The percentage of fiber tear of each adhesive sample was evaluated on regular cardboard (KRAFT cardboard) or hard to bond substrates (BOPP (Biaxially Oriented Polypropylene) film laminated Kraft or carton), at three different temperatures: room temperature, −17° C. and 60° C. The fiber tear results on these two different substrates were recorded. The adhesive was heated to 350° F./177° C., and was applied on the substrate cut into “1×3 in (25×76 mm)” rectangular sheets. The adhesive to be tested was applied, running lengthwise, at about a “5 mm/0.2 in” wide strip, and was drawn down with a spatula or hot melt applicator. Then a second strip was applied within two seconds and held, with moderate pressure, for five seconds to laminate.

The bonds, conditioned for 24 hours at room temperature and 54 percent RH, were then pulled apart at the test temperatures of room temperature, −17° C. and 60° C. Each bond was tested immediately, after the conditioning period ended. The bond was torn by inserting the blade of a spatula under one corner to fold up the corner. The bond was then placed on a horizontal surface, with the side with the folded corner faced up. With the laminate held as near as possible to the source of heating or cooling, in order to maintain the conditioning temperature, the folded corner is manually pulled as rapidly, as possible, at roughly a 45 to 90 degree angle, relative to each sheet's lengthwise axis, to tear the adhesive bond. The percent of torn fiber was estimated (fiber tear or FT) in 25 percent increments; that is, 0 percent, 25 percent, 50 percent, 75 percent and 100 percent. Unless otherwise stated, the FT test is normally repeated on five replicate samples, and the average of these five samples reported.

### Density

Density is measured in accordance with ASTM D-792. The density measured is a “quick density,” meaning that the density is determined after one hour from the time of molding. Test samples are compression molded at a temperature of 20° C. higher than the melting point of polymer, and at a pressure of 10 MPa for five minutes (dimensions of molded sample: 50 cm²×1-2 mm).

### Cloud Point Measurement

Cloud points were measured with a custom temperature-scanning turbidity (TST) apparatus which allowed for a throughput of 13 samples per run. The overall apparatus consisted of: (a) the TST heat block which holds 13 vials, connected to temperature controller (Watlow EZ-ZONE); (b) diffuse backlighting with a light panel and controller (Schott DCR IV, DC regulated 150W halogen light source); (c) a digital camera to image the TST; and (d) computer for storing images and for logging data.

The TST heat block consisted of: (a) an aluminum block with four symmetrically-distributed cartridge heaters, which had drilled recesses for 13 vials with cross-drilled holes for illumination; (b) a bolt-on aluminum cover plate with two cartridge heaters and small holes above each vial, which allowed for venting and for insertion of thermocouples to monitor temperature in the vials; (c) a ⅛″ thick copper gasket between (a) and (b) (not shown in picture) which provided head space clearance to avoid cracking of vials; (d) a glass-filled PEEK platform to which the TST was mounted, which served to effectively insulate the TST from the aluminum stand; and (e) control and overtemp thermocouples which were inserted in the TST heat block at middle and end locations.

Following are details of the TST method which was used to measure cloud points:
1) Specimens were loaded into the block.
2) Window guard was secured to enclosure. Camera and back light were turned on.
3) Using Qcapture, a picture was taken of the initial set-up and analyzed to ensure values were close to 4095 for an empty cell using Image J. The intensity and/or exposure times were adjusted until grayscale is about 200 (i.e., not fully saturated at 255). Greatest dynamic range was obtained for cloud point measurements if specimens were grouped on the basis of similar clarity.
4) TST program “TST 1712 software” was opened and “HMA TST” method was run.
5) The block was heated to an initial temperature of 180° C.
6) While heating, the temperature was monitored to ensure that the temperature controller was functioning properly.
7) The program was set to equilibrate the samples at 180° C. for 5 min. If temperature logging was required, the thermocouples were carefully inserted into four specimens with care taken to ensure that the thermocouples did not extend into the imaging window. After 5 min, the T controller was switched to Ramp-Soak mode to start the cooling program. Settings for 1° C./min cooling rate are ramp end point=45° C. & ramp duration=2:15 hr: min.
8) When fully cooled, vials were removed from heating block.

In-vial temperatures and ambient temperatures were logged with an 8-channel USB-TC DAQ device, K-type thermocouples, and Tracer DAQ Pro software (Measurement Computing). Readings of control and high-limit temperature controllers were recorded manually from the controller display. Sampling rate of 0.1 Hz (6 points/° C.) was sufficient because of the slow cooling rate. An acquisition duration of 165 min was chosen as it allowed for additional temperature monitoring beyond the programmed cooling ramp. Images were automatically captured with StreamPix software (NorPix).

In order to operate as a high throughput instrument, macros for image analysis, merging of time/temperature and time/intensity data were created. The following basic steps were used: (a) Put all images for a given run in a folder; (b) Use Excel™ macro which creates a spreadsheet list of all files in the folder. File names include a time stamp (example: HMA11_2016-12-12-15-57-32-525.tif) and Excel™ string and time functions can be used to extract time value associated with each image; (c) ImageJ (available from NIH) is used to determine grayscale (GS) values for all cells, one image at a time. In order to do this, the operator must tell the program where the light intensity should be analyzed for each sample. Accordingly the operator opens the first image in the folder (at high temperature where almost all blends are clear homogeneous melts) and use the multi-point selection tool to select a point in each cell (away from walls and any defects). After this, repeated alternation of CTL-M (to measure GS values in a running table) and CTL-SHFT-O (to open the next file in the folder) keystrokes then provides a GS value table for all cells and all images relatively rapidly. The operator merges GS values with image time stamps and associate specimen IDs with vial locations and processes the temperature log data. Lastly, the operator converts time stamps to more useful format (e.g., min), calculates the averages of channels 0-3 (ambient room air) and 4-7 (average vial temperature). These steps can all be converted into an ImageJ macro to batch process all images.

### EXAMPLES

The polymers used in this study are listed in Table 1. Tackifiers are shown below in Table 2.

TABLE 1
Polymers used in the Experimental Adhesive (HMA) Formulations

| | Calculated I2* | Melt | | | | |
|---|---|---|---|---|---|---|
| | at 190° C. | Viscosity | Density | Mw^{a} | Mn^{a} | |
| Polymer | (g/10 min) | at 177° C. (cP) | (g/cm3) | (g/mol) | (g/mol) | Mw/Mn^{a} |
| AFFINITY ™ GA | 1000 | 8200 | 0.870 | 20000 | 9523 | 2.1 |
| 1900^{b} | | | | | | |
| AFFINITY ™ GA | | | | | | |
| 1950^{b} | | | | | | |
| AFFINITY ™ GA | | | | | | |
| 1875^{b} | | | | | | |
| XUS 38628.00^{b} | | | | | | |
| AFFINITY ™ GA | 660 | 13000 | 0.878 | | | 2.7 |
| 1000R^{c} | | | | | | |

^{a}GPC results.
^{b}Available from The Dow Chemical Company. Ethylene/octene copolymer.
^{c}Available from The Dow Chemical Company. Maleic Anhydride (MAH) functionalized ethylene/octene copolymer.
*Melt index may be calculated from the following equation (See U.S. Pat. No. 6,335,410): I2(190° C./2.16 kg) = 3.6126[10^{(log(}η^{)-6.6928)/-1.1363}] − 9.31851, where η = melt viscosity, in cP, at 350° F. (177° C.).

TABLE 2
Rosin Based Tackifiers

| | | | Softening |
|---|---|---|---|
| Product | Esterification | Hydrogenation | point, ° C. |
| SYLVALITE ™ 2100 | | Pentaerythritol | 99 |
| | | ester | |
| SYLVALITE ™ 2200 | | Pentaerythritol | 98.5 |
| | | ester | |
| FORAL ™ 105-E^{a} | Pentaerythritol | Hydrogenated | 101 |
| | ester | Gum Rosin | |
| FORALYN ™ 90^{a} | Glycerol | Hydrogenated | 82 |
| | ester | Gum Rosin | |
| FORAL ™-AX-E | | Hydrogenated | 80 |
| | | Gum Rosin | |
| PERMALYN 6110^{a} | Pentaerythritol | Gum Rosin^{d} | 103 |
| | ester | | |

^{a}Available from Eastman Chemical.
c) Fully/Highly hydrogenated.
^{d}Non-hydrogenated; see WO 2005/014752.

TABLE 3
Hydrocarbon Based Tackifiers

| | | Softening |
|---|---|---|
| Product | Type | point, ° C. |
| REGALITE ™ | Hydrogenated | 100 |
| R1100 | hydrocarbon | |
| ESCOREZ ™ | Hydrogenated | 103.4 |
| 5400 | DCPD | |
| ESTOTAC ™ | Hydrogenated | 115 |
| H115R | hydrocarbon | |
| ESCOREZ ™ | Hydrogenated | 106.0 |
| 5600 | DCPD | |

### Adhesive Compositions

TABLE 4
Adhesive Formulations CE1-CE8 and IE1-IE3

| | AFFINITY | AFFINTIY | Sylvalite | Regalite | Escarez | | Total |
|---|---|---|---|---|---|---|---|
| Material | GA 1950 | GA 1000R | 2200 | R1100 | 5400 | Estotac H115R | parts |
| Control | 100 | | | | | | 100 |
| CE1 | 50 | | 50 | | | | 100 |
| CE2 | 50 | | | 50 | | | 100 |
| CE3 | 50 | | | | 50 | | 100 |
| CE4 | 50 | | | | | 50 | 100 |
| CE5 | 40 | 10 | 50 | | | | 100 |
| CE6 | 50 | | 25 | 25 | | | 100 |
| CE7 | 50 | | 25 | | 25 | | 100 |
| CE8 | 50 | | 25 | | | 25 | 100 |
| IE1 | 40 | 10 | 25 | 25 | | | 100 |
| IE2 | 40 | 10 | 25 | | 25 | | 100 |
| IE3 | 40 | 10 | 25 | | | 25 | 100 |

TABLE 5
Cloud Points of Adhesive compositions CE1-CE8 and IE1-IE3

| | | | Cloud |
|---|---|---|---|
| | | | point |
| Sample | Composition | Ratios | [c] |
| Control | GA 1950 | 100 | 71.3 |
| CE1 | GA1950/Sylvalite 2200 | 50/50 | 171.1 |
| CE2 | GA1950/Regalite R1100 | 50/50 | 54.1 |
| CE3 | GA1950/Escorez 5400 | 50/50 | 50.9 |
| CE4 | GA1950/Eastotac H115R | 50/50 | 52.1 |
| CE5 | GA1950/GA1000R/ | 40/10/50 | 174 |
| | Sylvalite 2200 | | |
| CE6 | GA1950/Sylvalite | 50/25/25 | 166.5 |
| | 2200/Regalite R1100 | | |
| CE7 | GA1950/Sylvalite | 50/25/25 | 164.8 |
| | 2200/Escorez 5400 | | |
| CE8 | GA1950/Sylvalite | 50/25/25 | 164.4 |
| | 2200/Eastotac H115R | | |
| IE1 | GA1950/GA1000R/Sylvalite | 40/10/25/25 | 101.3 |
| | 2200/Regalite R1100 | | |
| IE2 | GA1950/GA1000R/Sylvalite | 40/10/25/25 | 87.9 |
| | 2200/Escorez 5400 | | |
| IE3 | GA1950/GA1000R/Sylvalite | 40/10/25/25 | 90.3 |
| | 2200/Eastotac H115R | | |

As can be seen in Table 5, the addition of 1000R leads to a reduction in cloud point indicating that the addition of 1000R improves compatibility.

TABLE 6
Adhesive Formulations CE9-CE15 and IE4-IE7

| | AFFINITY | AFFINITY | Sylvalite | Foralyn | | | | Irganox | |
|---|---|---|---|---|---|---|---|---|---|
| Sample | GA 1950 | GA 1000R | 2200 | 110 | Escarez 5400 | Estotac H115R | Sasolwax | 1010 | Total parts |
| Control | 40 | | | | | 40 | 19.5 | 0.5 | 100 |
| CE9 | 40 | | 40 | | | | 19.5 | 0.5 | 100 |
| CE10 | 40 | | | 40 | | | 19.5 | 0.5 | 100 |
| CE11 | 40 | | | | 40 | | 19.5 | 0.5 | 100 |
| CE12 | 40 | | 20 | | 20 | | 19.5 | 0.5 | 100 |
| CE13 | 40 | | 20 | | | 20 | 19.5 | 0.5 | 100 |
| CE14 | 40 | | | 20 | 20 | | 19.5 | 0.5 | 100 |
| CE15 | 40 | | | 20 | | 20 | 19.5 | 0.5 | 100 |
| IE4 | 32 | 8 | 20 | | 20 | | 19.5 | 0.5 | 100 |
| IE5 | 32 | 8 | 20 | | | 20 | 19.5 | 0.5 | 100 |
| IE6 | 32 | 8 | | 20 | 20 | | 19.5 | 0.5 | 100 |
| IE7 | 32 | 8 | | 20 | | 20 | 19.5 | 0.5 | 100 |

TABLE 7
Physical Properties of Adhesive Formulations CE9-CE15 and IE4-IE7

| Sample | | Control | CE9 | CE10 | CE11 | CE12 | CE13 | CE14 | CE15 | IE4 | IE5 | IE6 | IE7 |
|---|---|---|---|---|---|---|---|---|---|---|---|---|---|
| Brookfield | cP | 1197 | 1140 | 1095 | 1143 | 1099 | 1140 | 1083 | 1096 | 1021 | 1030 | 1051 | 1054 |
| Viscosity, | | | | | | | | | | | | | |
| Softening | C. | 105 | 106 | 106 | 106 | 106 | 106 | 105 | 106 | 107 | 105 | 103.7 | 103.7 |
| Point (° C.) | | | | | | | | | | | | | |
| Open | sec | 15 | 9 | 8 | 12 | 14 | 13 | 14 | 14 | 13 | 14 | 10 | 13 |
| Time | | | | | | | | | | | | | |
| Set Time | sec | 2 | 2 | 2 | 2 | 2 | 1 | 2 | 2 | 2 | 2 | 2 | 2 |
| Fiber tear, | % | 62 | 50 | 30 | 35 | 55 | 70 | 55 | 50 | 65 | 69 | 70 | 60 |
| 60° C. | | | | | | | | | | | | | |
| Fiber tear, | % | 100 | 100 | 100 | 100 | 100 | 100 | 100 | 100 | 100 | 100 | 100 | 100 |
| RT | | | | | | | | | | | | | |
| Fiber tear, | % | 100 | 75 | 90 | 100 | 100 | 100 | 100 | 90 | 100 | 100 | 100 | 100 |
| 0° C. | | | | | | | | | | | | | |
| Fiber tear, | % | 60 | 15 | 5 | 45 | 79 | 15 | 50 | 32 | 100 | 94 | 79 | 60 |
| −17° C. | | | | | | | | | | | | | |
| Fiber tear, | % | 35 | 20 | 30 | 55 | 50 | 15 | 49 | 22 | 64 | 70 | 59 | 20 |
| −40° C. | | | | | | | | | | | | | |
| Heat | C. | 45 | 40 | 50 | 45 | 45 | 45 | 45 | 45 | 50 | 50 | 45 | 50 |
| Stress | | | | | | | | | | | | | |
| SAFT (° C.) | C. | 90.8 | 87.0 | 87.0 | 88.5 | 90.3 | 88.8 | 87.3 | 85.5 | 89.0 | 88.0 | 82.3 | 83.3 |
| PAFT (° C.) | C. | 56.5 | 44.3 | 53.5 | 58.8 | 53.0 | 58.5 | 54.5 | 57.5 | 57.5 | 57.5 | 55.8 | 58.5 |

Results shown in Table 7 above show rosin ester tackifier HMAs (Samples—CE9 and CE10) have lowest fiber tear (FT) performance. Samples—CE12, CE13, CE14 and CE15 are 50/50 blends of rosin ester/hydrogenated tackifier blends and demonstrate that blends alone do show modest improvements of fiber tear performance, but the benefit is not greater than 25% improvement. However, the benefit of adding GA 1000R can be observed in formulations—IE4, IE5, IE6 and IE7. In all cases where GA 1000R was added, the fiber tear window of good adhesion (with FT>75% observed) was extended to a broader temperature range. In the case of samples with Sylvalite 2200+GA 1000R, the best sample was Sylvalite/Eastotac H115R, which had FT>70% across the temperature range.

TABLE 8
Adhesive Formulations and Cloud Point Results for AFFINITY ™ GA/
GA 1000R/Rosin Ester Tackifier/Hydrogenated Hydrocarbon Tackifier.

| | | | | | | % rosin | % GA |
|---|---|---|---|---|---|---|---|
| | | | | | | ester of | 1000R of |
| Inventive | AFFINITY | AFFINTIY | Sylvalite | Escorez | | total | total |
| Examples | GA 1950 | GA 1000R | 2200 | 5400 | CP [C] | tackifier | polymer |
| P3-01 | 40 | 10 | 5 | 45 | 49.2 | 10.0 | 20 |
| P3-02 | 40 | 10 | 10 | 40 | 51.4 | 20.0 | 20 |
| P3-03 | 40 | 10 | 20 | 30 | 64.5 | 40.0 | 20 |
| P3-04 | 40 | 10 | 30 | 20 | 105.6 | 60.0 | 20 |
| P3-05 | 40 | 10 | 40 | 10 | 157.5 | 80.0 | 20 |
| P3-06 | 40 | 10 | 45 | 5 | 172.8 | 90.0 | 20 |
| P3-07 | 49 | 1 | 25 | 25 | 135.5 | 50.0 | 2 |
| P3-08 | 47 | 3 | 25 | 25 | 100.9 | 50.0 | 6 |
| P3-09 | 45 | 5 | 25 | 25 | 94.8 | 50.0 | 10 |
| P3-10 | 40 | 10 | 25 | 25 | 85.7 | 50.0 | 20 |
| P3-11 | 35 | 15 | 25 | 25 | 78.5 | 50.0 | 30 |
| P3-12 | 30 | 20 | 25 | 25 | 72 | 50.0 | 40 |
| P3-13 | 25 | 25 | 25 | 25 | 65.7 | 50.0 | 50 |

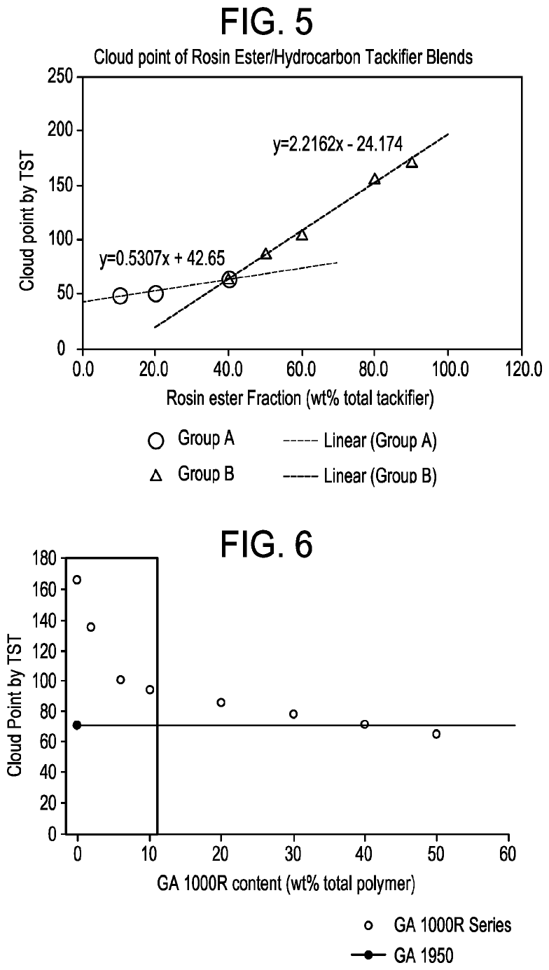

Table 8 summarizes a set of compositions aimed at exploring the effect of rosin ester content (% of total tackifier) and effect of maleic anhydride grafted polymer (% of total polymer) on cloud point results. Inventive Examples P3-01 through P3-06 systematically change the rosin ester tackifier from 10% to 90% of the total tackifier component, which is constant at 50% of the blend composition. As shown in the table and FIG. 4, the Cloud Point (deg C.) increases slowly with increasing rosin ester tackifier content between 10-40% and above 40 wt % the CP rate of change increases faster. FIG. 5 depicts two regions of Cloud Point behavior as a function of rosin ester tackifier. The rate of change (slope of line) of Cloud Point increases above 40% rosin ester tackifier These results indicate that formulations where the total tackifier content contains 40% or less of rosin ester tackifier would balance the benefit of rosin ester tackifier and maintain some compatibility of the system, as measured by a low cloud point. The cloud point of pure AFFINITY GA 1950 resin is 71° C. Blends with rosin ester tackifier content at 40% and below have a lower CP by TST, indicating favorable mixing conditions.

The effects of MAH-grafted POE (AFFINITY GA 1000R) on compatibility, as determined by cloud point, were also explored. Formulations and results are shown in Table 8, Inventive Examples P3-07 through P3-13. The data can be interpreted by range of change of cloud point (slope) for addition of GA 1000R. The largest impact is measured at levels of GA 1000R less than or equal to 10% total polymer. The region shown in green box in FIG. 6 highlights the maximized benefit of GA 1000R in the compositions evaluated. As can be seen with the addition of more 1000R the cloud point continues to reduce indicating that higher loading of 1000R improves compatibility.

1. An adhesive composition comprising of:
(A) an ethylene/alpha-olefin elastomer;
(B) a functionalized ethylene/alpha-olefin interpolymer;
(C) a rosin based tackifier; and
(D) a hydrocarbon based tackifier.

2. The adhesive composition of claim 1 further comprising of:
(A) from 30 to 45 wt % of the ethylene/alpha-olefin elastomer;
(B) from 0.1 to 20 wt % of the functionalized ethylene/alpha-olefin interpolymer;
(C) from 10 to 75 wt % of the rosin ester tackifier; and
(D) from 10 to 75 wt % of the hydrocarbon tackifier.

3. The adhesive composition of claim 1 further comprising of:
(A) from 20 to 50 wt % of the ethylene/alpha-olefin elastomer;
(B) from 1 to 10 wt % of the functionalized ethylene/alpha olefin interpolymer;
(C) from 15 to 30 wt % of the rosin ester tackifier; and
(D) from 15 to 30 wt % of the hydrocarbon tackifier.

4. The adhesive composition of claim 1 wherein the rosin ester tackifier and the hydrocarbon tackifier are present in a ratio of 1:1.

5. The adhesive composition of claim 1 wherein the ethylene/alpha-olefin elastomer and the functionalized ethylene/alpha-olefin interpolymer are present in the ratio of 4:1.

6. The adhesive composition of claim 2 wherein the rosin ester tackifier and the hydrocarbon tackifier are present in a ratio of 1:1.

7. The adhesive composition of claim 2 wherein the ethylene/alpha-olefin elastomer and the functionalized ethylene/alpha-olefin interpolymer are present in the ratio of 4:1.

8. The adhesive composition of claim 1 wherein the functionalized ethylene/alpha-olefin interpolymer is a maleic anhydride and/or carboxylic acid functionalized ethylene/alpha-olefin interpolymer with a melt index (I2), or calculated melt index (I2), less than, or equal to, 1500 g/10 min.

9. The adhesive composition of claim 4 wherein the functionalized ethylene/alpha-olefin interpolymer is a maleic anhydride and/or carboxylic acid functionalized ethylene/alpha-olefin interpolymer with a melt index (I2), or calculated melt index (I2), less than, or equal to, 1500 g/10 min.

10. The adhesive composition of claim 5 wherein the functionalized ethylene/alpha-olefin interpolymer is a maleic anhydride and/or carboxylic acid functionalized ethylene/alpha-olefin interpolymer with a melt index (I2), or calculated melt index (I2), less than, or equal to, 1500 g/10 min.
